(19) United States
(12) Patent Application Publication
(10) Pub. No.: US 2007/0043310 A1
(43) Pub. Date: Feb. 22, 2007

(54) Method and apparatus for monitoring patient compliance during dynamic motion therapy

(75) Inventors: Titi Trandafir, S. Plainfield, NJ (US); Roger J. Talish, Hillsborough, NJ (US); Kenneth Urgovitch JR., Montague, NJ (US); Donald E. Krompasick, Bethlehem, PA (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Juvent Inc., Somerset, NJ (US)

(21) Appl. No.: 11/486,538

(22) Filed: Jul. 14, 2006

Related U.S. Application Data
(63) Continuation-in-part of application No. 11/369,611, filed on Mar. 6, 2006.
(63) Continuation-in-part of application No. 11/388,286, filed on Mar. 24, 2006.
(60) Provisional application No. 60/659,159, filed on Mar. 7, 2005.
(60) Provisional application No. 60/665,013, filed on Mar. 24, 2005.
(60) Provisional application No. 60/702,815, filed on Jul. 27, 2005.
(60) Provisional application No. 60/702,735, filed on Jul. 27, 2005.

(51) Int. Cl. A61H 7/00

(52) U.S. Cl. 601/90; 601/84; 601/93

(57) ABSTRACT

A system and apparatus for remote monitoring of data related to therapeutic treatment of tissue are provided. The system and apparatus includes a platform configured to support a body of the patient; an oscillator connected to the platform and configured to impart an oscillating force at a predetermined frequency on the platform for transmitting mechanical vibration energy through the patient's body; and a processing device in operable communication with the platform for processing data related to the therapeutic treatment. The apparatus further includes a communication device in operative communication with the processing device.

### PRIORITY

The present application is a Continuation-In-Part patent application of a U.S. patent application filed on Mar. 6, 2006 titled “Supplemental Support Structures Adapted to Receive a Non-invasive Dynamic Motion Therapy Device” and assigned U.S. patent application Ser. No. 11/369,611; the contents of which are hereby incorporated by reference. U.S. patent application Ser. No. 11/369,611 claims priority from a U.S. Provisional Application filed on Mar. 7, 2005 and assigned U.S. Provisional Application No. 60/659,159; the contents of which are hereby incorporated by reference.

The present application is also a Continuation-In-Part patent application of a U.S. patent application filed on Mar. 24, 2006 titled “Apparatus and Method for Monitoring and Controlling the Transmissibility of Mechanical Vibration Energy During Dynamic Motion Therapy” and assigned U.S. patent application Ser. No. 11/388,286; the contents of which are hereby incorporated by reference. U.S. patent application Ser. No. 11/388,286 claims priority from a U.S. Provisional Application filed on Mar. 24, 2005 and assigned U.S. Provisional Application No. 60/665,013; the contents of which are hereby incorporated by reference.

The present application further claims the benefit of and priority to U.S. Provisional Application filed on Jul. 27, 2005 titled “Method and Apparatus for Monitoring Patient Compliance During Dynamic Motion Therapy” and assigned U.S. Provisional Application Ser. No. 60/702,815; the contents of which are hereby incorporated by reference. Additionally, the present application claims the benefit of and priority to U.S. Provisional Application filed on Jul. 27, 2005 titled “Dynamic Motion Therapy Apparatus Having a Treatment Feedback Indicator” and assigned U.S. Provisional Application Ser. No. 60/702,735; the contents of which are hereby incorporated by reference.

### CROSS-REFERENCE TO RELATED PATENTS

The present application is related to U.S. Pat. Nos. 6,843,776 and 6,884, 227, the contents of which are hereby incorporated by reference.

### BACKGROUND

1. Technical Field

The present disclosure generally relates to the field of stimulating tissue growth and healing, and more particularly, the present disclosure describes dynamic motion therapy apparatus having remote monitoring station for remotely monitoring data related to therapeutic treatment of tissue in a body during dynamic motion therapy. More specifically, the present disclosure relates to a method and apparatus for remotely monitoring data related to therapeutic treatment of damaged tissues, bone fractures, osteopenia, osteoporosis, or other tissue conditions, as well as postural instability, using dynamic motion therapy and mechanical impedance methods.

2. Background of the Related Art

When damaged, tissues in a human body such as connective tissues, ligaments, bones, etc. all require time to heal. Some tissues, such as a bone fracture in a human body, require relatively longer periods of time to heal. Typically, a fractured bone must be set and then the bone can be stabilized within a cast, splint or similar type of apparatus. This type of treatment allows the natural healing process to begin. However, the healing process for a bone fracture in the human body may take several weeks and may vary depending upon the location of the bone fracture, the age of the patient, the overall general health of the patient, and other factors that are patient-dependent. Depending upon the location of the fracture, the area of the bone fracture or even the patient may have to be immobilized to encourage complete healing of the bone fracture. Immobilization of the patient and/or bone fracture may decrease the number of physical activities the patient is able to perform, which may have other adverse health consequences. Osteopenia, which is a loss of bone mass, can arise from a decrease in muscle activity, which may occur as the result of a bone fracture, bed rest, fracture immobilization, joint reconstruction, arthritis, and the like. However, this effect can be slowed, stopped, and even reversed by reproducing some of the effects of muscle use on the bone. This typically involves some application or simulation of the effects of mechanical stress on the bone.

Promoting bone growth is also important in treating bone fractures, and in the successful implantation of medical prostheses, such as those commonly known as “artificial” hips, knees, vertebral discs, and the like, where it is desired to promote bony ingrowth into the surface of the prosthesis to stabilize and secure it. Numerous different techniques have been developed to reduce the loss of bone mass. For example, it has been proposed to treat bone fractures by application of electrical voltage or current signals (e.g., U.S. Pat. Nos. 4,105,017; 4,266,532; 4,266,533, or 4,315,503). It has also been proposed to apply magnetic fields to stimulate healing of bone fractures (e.g., U.S. Pat. No. 3,890,953). Application of ultrasound to promoting tissue growth has also been disclosed (e.g., U.S. Pat. No. 4,530,360).

While many suggested techniques for applying or simulating mechanical loads on bone to promote growth involve the use of low frequency, high magnitude loads to the bone, this has been found to be unnecessary, and possibly also detrimental to bone maintenance. For instance, high impact loading, which is sometimes suggested to achieve a desired high peak strain, can result in fracture, defeating the purpose of the treatment.

It is also known in the art that low level, high frequency stress can be applied to bone, and that this will result in advantageous promotion of bone growth. One technique for achieving this type of stress is disclosed, e.g., in U.S. Pat. Nos. 5,103,806; 5,191,880; 5,273,028; 5,376,065; 5,997,490; and 6,234,975, the entire contents of each of which are incorporated herein by reference. In this technique (referred to as dynamic motion therapy), the patient is supported by an oscillating platform apparatus that can be actuated to oscillate vertically, so that resonant vibrations caused by the oscillation of the platform, together with acceleration brought about by the body weight of the patient, provides stress levels in a frequency range sufficient to prevent or reduce bone loss and enhance new bone formation. The peak-to-peak vertical displacement of the platform oscillation may be as little as 2 μm.

However, these systems and associated methods often depend on an arrangement whereby the operator or user must measure the weight of the patient and make adjustments to the frequency of oscillation to achieve the desired therapeutic effect. U.S. Pat. No. 6,843,776 discloses an oscillating platform apparatus that automatically measures the weight of the patient and adjusts characteristics of the oscillation force as a function of the measured weight, to therapeutically treat damaged tissues, bone fractures, osteopenia, osteoporosis, or other tissue conditions.

It is also known in the art that the application of low level, high frequency stress is effective in treating postural instability. A method of using resonant vibrations caused by the oscillation of a vibration table or unstable vibrating platform for treating postural instability is described in U.S. Pat. No. 6,607,497 B2; the entire contents of which are incorporated herein by reference. The method includes the steps of (a) providing a non-invasive dynamic therapy apparatus having a vibration table with a non-rigidly supported platform; (b) permitting the patient to rest on the non-rigidly supported platform for a predetermined period of time; and (c) repeating the steps (a) and (b) over a predetermined treatment duration. Step (b) includes the steps of (b1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 B2 entails the patient standing on the vibration table or the unstable vibrating platform. The patient is then exposed to a vibrational stimulus by the unstable vibrating platform. The unstable vibrating platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day in an effort to improve the postural stability of the patient.

The patient undergoing vibrational treatment for treating postural instability and/or the promotion of bone growth, as described above, may experience a level of discomfort due to whole-body vibration acceleration. The level of discomfort caused by vibration acceleration depends on the vibration frequency, the vibration direction, the point of contact with the body, and the duration of the vibration exposure. It is desirable to monitor at least one mechanical response of the body during vibrational treatment in an effort to control the at least one mechanical response to influence comfort level, as well as to determine patient- and treatment-related characteristics. Two mechanical responses of the body that are often used to describe the manner in which vibration causes the body to move are transmissibility and mechanical impedance.

The transmissibility shows the fraction of the vibration which is transmitted from, say, the vibration table or oscillating platform apparatus to the head of the patient. The transmissibility of the body is highly dependent on vibration frequency, vibration axis and body posture. Vertical vibration on the non-invasive dynamic therapy device causes vibration in several axes at the head; for vertical head motion, the transmissibility tends to be greatest in the approximate range of 3 to 10 Hz.

The mechanical impedance of the body shows the force that is required to make the body move at each frequency. Although the impedance depends on body mass, the vertical impedance of the human body usually shows a resonance at about 5 Hz. The mechanical impedance of the body, including this resonance, has a large effect on the manner in which vibration is transmitted through seats.

### SUMMARY

It is an aspect of the present disclosure to provide a method and apparatus for monitoring data related to therapeutic treatment of tissue in a body of a patient. It is also an aspect of the present disclosure to provide a method and apparatus for communication with a central monitoring station via a network, such as, for example, the internet and transmitting patient compliant data to a remote monitoring station for monitoring. Patient compliant data (directed to whether the patient is complying to treatment protocols) and other patient and treatment related data are preferably stored in a dynamic therapy system for evaluation at a later time or for transmission via the network using a communications circuitry to the central monitoring station for observation. The transmission can also occur in real time during dynamic motion therapy for enabling a medical professional or other observer to transmit data via the network to the patient during the therapy session.

The present disclosure describes dynamic motion therapy apparatus having a remote monitoring station for monitoring patient compliance during therapeutic treatment of tissue during dynamic motion therapy. In particular, the present disclosure provides a method and system for remotely monitoring data related to therapeutic treatment of tissue in a body during dynamic motion therapy. The dynamic motion therapy apparatus generally includes a platform configured to support a body of the patient, an oscillator operably connected to the platform and configured to impart an oscillating force at a predetermined frequency on the platform; and a processing device in operable communication with the platform and configured for processing data related to the therapeutic treatment. The system further includes a communication device in operative communication with the processing device and a display for displaying treatment and other information to the patient.

The communication device is adapted for transmitting the processed data to a remote monitoring station via at least one network. The communication device is adapted for transmitting data to a remote station, such as for example, a doctor's office. The data transmitted is indicative of at least one treatment parameter such as, for example, a vibrational response of the patient's musculoskeletal system, the amplitude of the frequency of the oscillating force, oscillation frequency, a calculated weight, and the time interval of the treatment.

The communication device may be, for example, a cellular phone having a port connector capable of connecting to the communication device for receiving the data via the port connector-communication interface connection and for transmitting said data to the remote monitoring station via a CDA cellular communications network according to the CDMA communications protocol. The communication device may also be, for example, a PDA having a port connector capable of connecting to the communication device for receiving the data via the port connector-communication interface and for transmitting the received data to a PSTN, form where it is transmitted through the Internet according to the Internet protocol, and then to another PSTN connected to the central computer station.

The communication device may also operate in accordance with a communication protocol, as is well known in the art, preferably, a TCP/IP protocol. Moreover, the communication device may transmit data via a communication medium, such as, for example, copper wire, phone line connection, internet connection, optical fibre, radio-link, laser, radio or infrared light.

The present disclosure further provides a method for effectively monitoring data related to therapeutic treatment of tissue in a body of a patient. The method includes the step of supporting the body on a platform; oscillating the platform at an oscillation frequency to impart an oscillating force on the body to treat the tissue in the body; and obtaining data by at least one processing device or digital signal processor. The data obtained is related to at least one treatment parameter during oscillating of the body. The method further includes transmitting the data to a remote monitoring station for monitoring thereof. The method further includes transmitting a control signal from the remote station to the at least one processing device for remotely controlling a value of the at least one treatment parameter. The at least one treatment parameter may be a calculated weight, a vibrational response of a musculoskeletal system of the patient, amplitude of the frequency of the oscillating force, and a time interval of the duration of the treatment. The frequency of oscillation or oscillating frequency is not changed during treatment.

During dynamic motion therapy, the digital signal processor determines and monitors the weight of the patient. The dynamic (apparent) weight of the patient is continuously in real-time or periodically measured and stored within the digital signal processor to determine the posture of the patient and accordingly, the transmissibility of the mechanical vibration energy through the patient or oscillating platform system-seat/support structure-patient interface, since the posture of the patient and dynamic stiffness of the seat/support structure affects the transmissibility of the mechanical vibration energy through the patient.

If the calculated weight during dynamic motion therapy differs or deviates significantly (i.e., more than a predetermined threshold) from the apparent weight, the digital signal processor determines that the patient's posture changed thereby decreasing or increasing the transmissibility of the mechanical vibration energy depending on whether the calculated weight decreased (transmissibility decreased) or increased (transmissibility increased). If the calculated weight decreased, it can be assumed that the patient has deviated from or is not compliant with the dynamic motion therapy treatment protocol. It is one object of the invention to provide a system for generating and transmitting a message instructing the patient to comply with the dynamic motion therapy treatment, e.g. change posture. Accordingly, by adjusting the posture and/or dynamic stiffness of the seat (or other support structure) resting on the oscillating platform system to bring the calculated weight to approximate the apparent weight, the transmissibility of the mechanical vibration energy through the patient or oscillating platform apparatus-seat/support structure-patient interface can be influenced, as well as dynamic loading, for maximizing the treatment effects caused by dynamic motion therapy.

The step of transmitting data includes transmitting data via a communications medium, such as, for example, copper wire, phone line connection, internet connection, optical fibre, radio-link, laser, radio or infrared light.

### BRIEF DESCRIPTION OF THE DRAWINGS

The foregoing features of the present disclosure will become more readily apparent and will be better understood by referring to the following detailed description of preferred embodiments, which are described hereinbelow with reference to the drawings wherein:

FIG. 1 is a perspective view illustrating a non-invasive dynamic motion therapy apparatus having a display unit for displaying treatment feedback, in accordance with the present disclosure.

FIG. 2 is a perspective view of an of an ergonomic support structure having an ergonomic hand support structure, a monitor provided on a column having a monitor for displaying treatment information feedback and a platform for supporting the non-invasive dynamic motion therapy device in accordance with the present disclosure;

FIG. 3 is a flow chart illustrating a method in accordance with the present disclosure; and

FIG. 4 is schematic block diagram of the non-invasive dynamic motion therapy apparatus in accordance with the present disclosure.

### DETAILED DESCRIPTION

The dynamic motion therapy apparatus and method in accordance with various embodiments of the disclosure provide a method and system for monitoring patent compliance when undergoing treatment of damaged tissue, bone fractures, osteopenia, osteoporosis, or other tissue conditions, as well as postural instability, using dynamic motion therapy and mechanical impedance methods. Dynamic motion therapy apparatus has an oscillating platform for positioning the patient thereon for providing low displacement, high frequency mechanical loading of bone tissue.

The dynamic motion therapy apparatus includes communication circuitry in operative communication with at least one processing device or digital signal processor for transmitting and receiving data from and to a central, remote monitoring station. The data transmitted can include patient monitoring data to determine, at the central monitoring station, whether the patient is complying with a treatment regimen; and data to determine whether the patient is properly positioned on the dynamic motion therapy device to obtain optimum treatment effects. The apparatus further includes circuitry and related components including a treatment feedback indicator for providing treatment feedback relating to the transmissibility of mechanical vibration energy during therapeutic treatment of tissue, as described in U.S. Provisional Application Ser. No. 60/702,815.

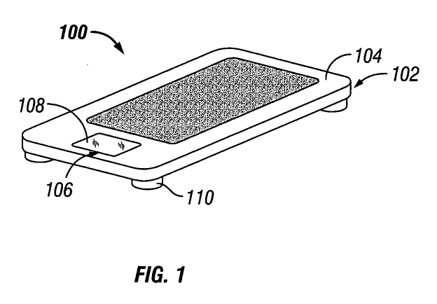

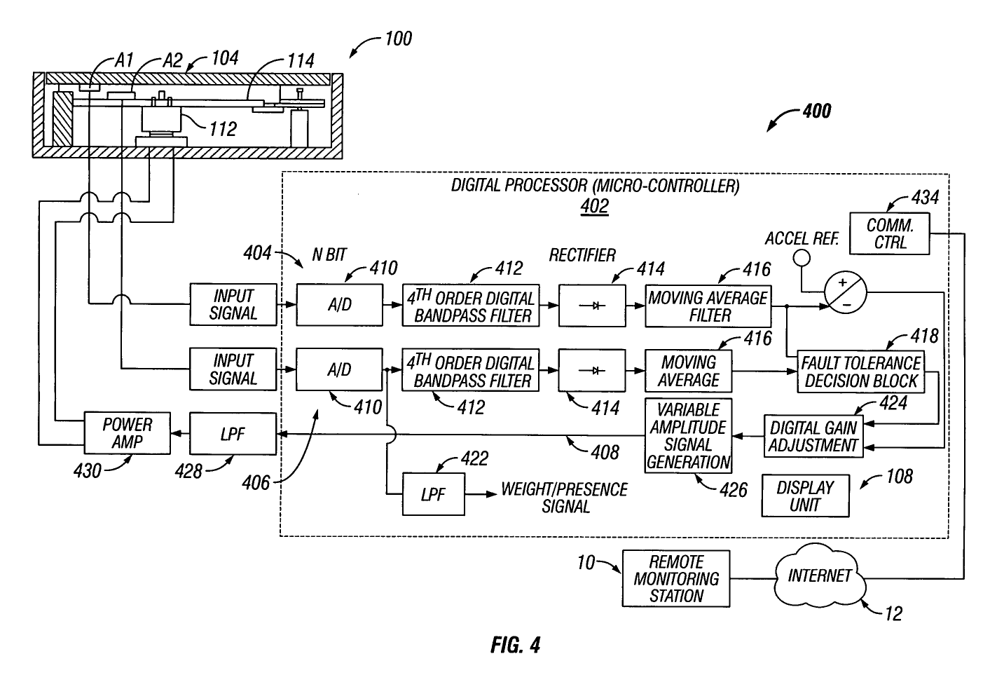

Referring initially to FIG. 1, there is illustrated a perspective view of a non-invasive dynamic motion therapy apparatus in accordance with the present disclosure. The apparatus having a treatment feedback indicator is designated generally by reference numeral 100. Apparatus 100 includes a vibration table 102 having a non-rigidly supported platform 104. At least one processing device or digital signal processor 402 (see FIG. 4), is in operative communication with platform 104 for processing data related to the therapeutic treatment. Apparatus 100 further includes a treatment feedback indicator 106 having a display 108 operably connected to the processing device 402 for providing transmissibility information and/or for displaying other information to the patient. Apparatus 100 further includes foot rests 110 for resting the apparatus 100 on a flat surface.

The non-rigidly supported platform 104 rests on motorized spring mechanisms (not shown) which cause the platform 104 to move when they are turned on. Alternatively, the non-rigidly supported platform 104 may rest on a plurality of springs or coils which cause the non-rigidly supported platform 104 to move once a patient stands thereon. Further, the non-rigidly supported platform 104 can include various compliant modalities other than springs (e.g., rubber, elastomers, foams, etc.).

In an alternative embodiment, apparatus 100 includes a platform housed within a housing and having first and second accelerometer, as described in U.S. patent application Ser. No. 11/388,286.

It is envisioned that apparatus 100 may include a communication device in operable communication with the processing device 402 and adapted for transmitting data to a remote monitoring station via at least one network. The communication device is, for example, a cellular phone having a port connector capable of connecting to the communication device for receiving the data via the port connector-communication interface connection and for transmitting said data to the remote monitoring station via a CDA cellular communications network according to the CDMA communications protocol. The communication device may also be, for example, a PDA having a port connector capable of connecting to the communication device for receiving the data via the port connector-communication interface and for transmitting the received data to a PSTN, form where it is transmitted through the Internet according to the Internet protocol, and then to another PSTN connected to the central computer station. The communication device may also operate in accordance with a communication protocol, as is well known in the art, preferably, a TCP/IP protocol. Moreover, the communication device may transmit data via a communication medium, such as, for example, copper wire, phone line connection, internet connection, optical fibre, radio-link, laser, radio or infrared light.

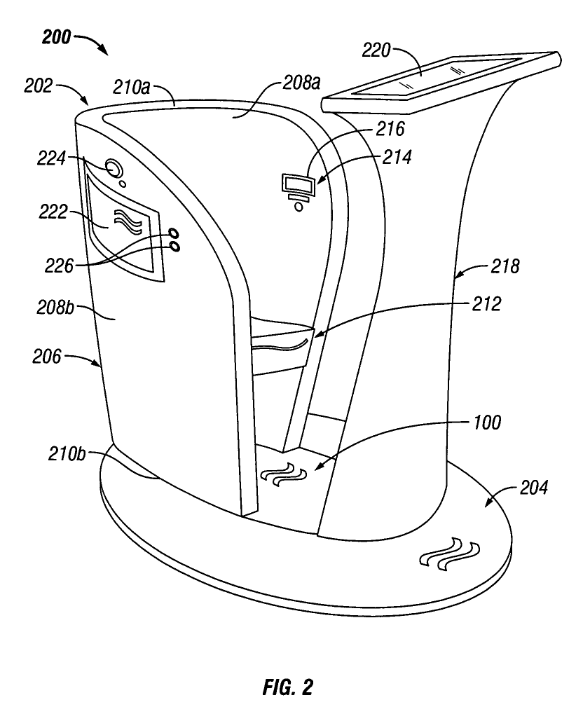

With reference to FIG. 2, apparatus 100 in accordance with the present disclosure is received by a supplemental support structure. In a preferred embodiment of a supplemental support structure, an ergonomic support structure is provided and is designated generally by reference numeral 200. The ergonomic support structure 200 includes an ergonomic hand support structure 202 and a platform 204 for supporting apparatus 100. Apparatus 100 is preferably removable from platform 204.

Ergonomic hand support structure 202 includes a curved structure 206 having inner and outer curved walls 208a, 208b and two curved ends 210a, 210b connecting the two walls 208a, 208b. During vibrational treatment by the non-invasive dynamic motion therapy apparatus 100, the patient grasps the long curved end 210a or lightly touches the inner curved wall 208a.

A patient suffering from a severe case of postural instability or other condition which prevents the patient from standing on the non-rigidly supported platform 100 can be seated on a removable seat 212 and be treated with dynamic motion therapy device 100. Seat 212 is adapted for placement on two opposing surfaces (not shown) defined by the inner curved wall 208a.

Ergonomic support structure 200 further includes an RFID reader 214 for reading an RFID tag provided on the patient for identifying the patient. The RFID reader 214 further includes a display 216 for displaying patient identification data and other data, including video. The RFID reader 214 also includes a processor (not shown) storing patient-related data, such as patient identification data, and treatment data, such as, for example, the dates and duration times of the last five vibrational treatment sessions. The patient-related data for each particular patient is accessed and portions thereof displayed by the display 216 after the patient's corresponding RFID tag is read by the RFID reader 214.

With continued reference to FIG. 2, ergonomic support structure 200 further includes a vertical column 218 having a monitor 220 for displaying patient identification data and other data, such as patient treatment data, including video. Preferably, the monitor 220 is inlaid within the vertical column 218 for enabling the patient to place a book, laptop, etc. on the vertical column 218 without contacting the monitor 220. The vertical column 218 is preferably height adjustable to accommodate patients of differing heights. Monitor 220 is preferably touch-sensitive for controlling the operation of the non-invasive dynamic motion therapy device 100 and performing other functions, such as accessing the Internet, accessing data stored within a memory, etc., by touching the screen of the monitor 220. Another monitor 222 is provided on the outer wall 208b. The outer wall 208b is further provided with a light source 224 above the monitor 222 and control buttons 226.

Ergonomic support structure 200 is provided with circuitry and related components for connecting to a network, such as the Internet, wirelessly and/or non-wirelessly and at least one processor for transmitting and receiving data via the network as known in the art. The data transmitted can include patient monitoring data to determine at a central monitoring station if the patient is complying with a treatment regimen and data to determine whether the patient is properly positioned on the dynamic motion therapy apparatus to obtain optimum treatment effects. The data can include video and/or sensor data obtained by a video camera and/or at least one sensor mounted to the support structures and transmitted via the network to the central monitoring station. The data received can include Internet content and treatment-related data transmitted from the central monitoring station. The data received can include visual and/or audio content for viewing via the monitor 220 and/or listening via earphones connected to audio circuitry embedded within the support structures.

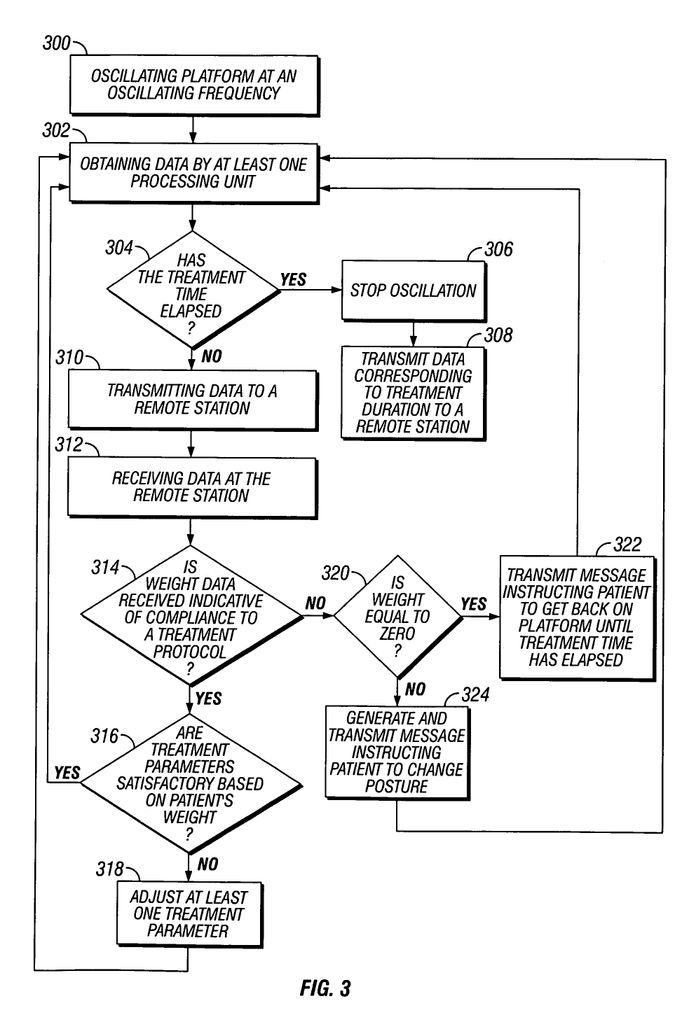

With reference to FIG. 3, there is a flow chart illustrating an exemplary method for providing therapeutic treatment of tissue in accordance with the present disclosure. The method includes the step of supporting the body on a platform 104. Step 300 includes oscillating platform 104 at an oscillation frequency to impart an oscillating force on the body to treat the tissue in the body. Step 302 includes the step of obtaining data via processing device 402. The data is related to at least one treatment parameter during oscillation of the body. The treatment parameter includes, for example, the weight of the patient, the oscillation frequency of platform 104; an amplitude of the frequency of the oscillating force generated by the oscillating frequency; and a time interval duration of the treatment. Obtaining data relating to a vibrational response of a musculoskeletal system of the patient is also envisioned.

Table 1 illustrates a list of exemplary data corresponding to a treatment duration of 10 minutes and their corresponding transmissibility value indicating the average weight and average amplitude.

TABLE 1

| Time Interval | Average | Average |
|---|---|---|
| (minutes) | Weight (lbs) | Amplitude (mm) |
| 1 | 155 | 1.5 |
| 2 | ↓ | ↓ |
| 3 | ↓ | ↓ |
| 4 | ↓ | ↓ |
| 5 | ↓ | ↓ |
| 6 | ↓ | ↓ |
| 7 | ↓ | ↓ |
| 8 | ↓ | ↓ |
| 9 | ↓ | ↓ |
| 10 | ↓ | ↓ |

Following the step of obtaining the data via processing unit 400 (Step 302), the system will verify whether the predetermined treatment duration has elapsed. If the treatment duration has elapsed, then the step of oscillating platform 104 is discontinued (Step 306) and data corresponding to treatment duration is transmitted to the remote monitoring station (Step 308). If the treatment time has not elapsed then data relating to treatment parameters are transmitted to the remote monitoring station (Step 310). In Step 312, the remote monitoring station receives the data relating to the treatment parameters, i.e. weight of the patient, the oscillation frequency of platform 104, an amplitude of the oscillating force, and a time interval duration of the treatment, as illustrated in Table 1. The remote monitoring station determines whether data relating to weight is indicative of compliance to a treatment protocol (Step 314).

Since the posture of the patient and dynamic stiffness of the seat/support structure affects the weight of the patient and thus the transmissibility of the mechanical vibration energy through the patient, the processing device 402 determines and monitors the weight of the patient. The weight of the patient is continuously, in real time or periodically, compared to an apparent weight to determine a deviation value (Apparent Weight minus Calculated Weight), i.e., weight data, (Step 314). If the weight data indicates that the calculated weight is equal to zero (Step 320) (that is, the deviation value is substantially equal to the apparent weight), it is determined that the patient has stepped off the platform 104. A message is transmitted to the patient at Step 322 instructing the patient to resume the treatment until the predetermined treatment time has elapsed. The process then proceeds to Step 302.

If weight data indicates that the calculated weight is not equal to zero, i.e. the platform is still supporting the patient, and the deviation value is positive and greater than a predetermined threshold, it is determined that the patient's posture is incorrect and a message is generated and transmitted to the display unit 166 instructing patient to change or correct posture (Step 324). The process then proceeds to Step 302. If the calculated weight does not differ significantly from the apparent weight as determined by the processing device 402, i.e., deviation value is substantially zero, (patient is complying to treatment protocol), then at Step 316 it is determined whether the treatment parameters are satisfactory based on the weight of the patient. If yes, the process then proceeds to Step 302. If no, then at Step 318, at least one treatment parameter, e.g., amplitude of the oscillating force, is adjusted and the process proceeds to Step 302. The frequency of oscillation or oscillating frequency is not changed during treatment. The apparatus 100 during the initial tune-up performs a self-evaluation (calibration) and does a frequency sweep between 32 and 37 Hz to find the maximum acceleration for the particular user. After the initial tune-up, the apparatus 100 maintains the chosen oscillating frequency for the rest of the treatment duration.

With reference to FIG. 4, there is shown a schematic block diagram of the dynamic motion therapy apparatus 100 in accordance with the disclosure. Schematic block diagram includes at least one processing device or digital signal processor as described in U.S. patent application Ser. No. 11/388,286 filed on Mar. 24, 2006; the entire contents of which are hereby incorporated by reference. The dynamic motion therapy apparatus 100 includes platform 104 and two accelerometers A1, A2 for transmitting information to the processing device 402. Processing device 402 is preferably a digital signal processor 402 as shown by FIG. 4 having circuitry and programmable instructions stored within a memory and capable of being executed by the digital signal processor 402 for operating the dynamic motion therapy apparatus 100. The digital signal processor 402 includes two incoming data paths 404, 406 having identical components for processing data received from the two accelerometers A1, A2 and one outgoing data path 408 for relaying control or feedback signals to the oscillating actuator 112 for causing vibration of the platform 104 via drive lever 114.

Digital signal processor 402 includes a memory storing a set of programmable instructions capable of being executed by the digital signal processor 402 for operating the components of the two incoming data paths 404, 406 and one outgoing data path 408 for performing the functions described above in accordance with the disclosure, as well as other functions. The set of programmable instructions can also be stored on a computer-readable medium, such as a CD-ROM, diskette, and other magnetic media, and downloaded to the digital signal processor 402.

Each incoming data path includes four major components for processing the incoming data from the two accelerometers A1, A2. The four major components are in order from left to right in FIG. 4 an analog-to-digital (A/D) converter 410, a bandpass filter 412, a rectifier 414, a moving average filter 416, and a fault tolerance decision block 418.

Preferably, the bandpass filter 412 in each incoming data path is a 4^{th} order elliptic bandpass filter which finds the “sweet spot” for each particular patient (this causes the processor to shift the resonance of the dynamic therapy system 400 based on the patient's mass or weight by transmitting a signal to the oscillating actuator 112 to change the frequency of the oscillating force). The digital signal processor 402 processes the polynomial coefficients of the 4^{th} order elliptic bandpass filters by implementing “power of two” coefficients. The processor 402 is programmed to do this instead of performing polynomial multiplication for each coefficient in the polynomial which would require a significantly longer processing time. The processor 402 in accordance with the present disclosure reduces processing time by approximating the polynomial coefficients using the “power of two.” For example, if the coefficient is 3.93215, the processor 402 can perform a quick approximation of the coefficient by approximating the coefficient as follows: 4 1/16+ 3/128− 1/512. It is contemplated that the same method can be used to process the coefficients of the other filters of the processor 402.

The output from the moving average filter 416 of incoming data path 404 is provided to the fault tolerance decision block 418 for determining fault tolerance level and an adder/subtracter block 420 for deciding whether to increase or decrease the gain to maintain the average vibration intensity to a preset value. The output of block 420 is an error signal which determines whether to increase or decrease the vibration level of the oscillating actuator 112.

The output from the adder/subtractor block 420 is the acceleration of the patient and the output from A/D converter 410 of incoming data path 406 is provided to a low-pass filter 422 which outputs a weight/presence signal. The weight/presence signal is used to sense the presence of the patient and to calculate the weight of the patient continuously or periodically using conventional weight/angle equations during dynamic motion therapy.

By determining the weight of the patient during treatment and comparing the weight to the apparent weight as described above, the processor 402 is able to determine whether the patient is compliant with the treatment protocols (e.g., whether patient is resting, standing, etc. on platform 104) and the posture of the patient for determining the transmissibility of the mechanical vibration energy through the patient. The patient can then influence the transmissibility, if necessary (i.e., if the calculated weight indicates poor transmissibility), by shifting or changing his posture accordingly.

The acceleration value of the patient and the output from the fault tolerance decision block 418 are inputs at separate times (since the processor 402 of the dynamic motion therapy system 400 is designed as a real time interrupt driven software system as described below) during operation of the dynamic therapy system 400 to the outgoing data path 408.

The outgoing data path 408 includes four major components for processing control and feedback signals transmitted from the processor 402 to the oscillating actuator 112. The four major components are in order from right to left in FIG. 4 a digital gain adjustment module 424 for performing automatic gain control as described above, a variable amplitude signal generation module 426 for increasing or decreasing the sinusoidal signal driving the oscillating actuator 112, a low-pass filter 428 for filtering the control and feedback signals and a power amplifier 430 for amplifying the control and feedback signals.

Apparatus 100 includes a treatment feedback indicator 500, 500′ which in a preferred embodiment includes display unit 106 for displaying treatment related information (amount of mechanical vibration energy transmitted through the patient) and other information, such as diagnostic information, to the patient, medical professional or other individual. The treatment-related information can include the original calculated weight of the patient and the calculated weight of the patient during treatment, the acceleration of the patient, automatic gain control information, level or degree of compliance to the treatment protocols, a transmissibility value indicating or approximating the amount of mechanical vibration energy being transmitted through the patient or support structure-patient during treatment etc.

The digital signal processor 402 of the dynamic motion therapy apparatus 100 is designed as a real time interrupt driven software system (the apparatus 100 does not have a main loop). A timer interrupt occurs every 1/fs milliseconds. That is, for example, if the apparatus 100 is tuned at 34 Hz, a timer interrupt occurs every 1/34 seconds. A different function occurs during each timer interrupt, such as replenishing or updating the display unit 432, transmitting the control or feedback signals to the oscillating actuator 112, and generating a transmitting a sine wave to the oscillating actuator 112 for automatic gain control (the sine wave is preferably generated and transmitted approximately 500 times per second). It is contemplated that higher priority interrupts are performed first. If there is not interrupt to be performed, the processor 402 goes into an idle mode until there is an interrupt to perform.

The digital signal processor 402 generates the (sinusoidal) signal to the oscillating actuator 112 and processes the acceleration signal received from accelerometer A1 using at least one digital bandpass filter 412 with a variable sampling rate during calibration (tuning) of the dynamic motion therapy apparatus 100. In the dynamic motion therapy apparatus 100, the sampling rate and thus the vibration frequency is between 0 and 250 Hz, with the at least one digital bandpass filter 412 adaptively tuned to the current operating frequency. The variable sampling rate is possible due to the interrupt driven software system of the software control loop as described above.

The dynamic therapy apparatus 100 further includes communication circuitry/device 434 for downloading/uploading data, including software updates, to the processor 402 and for communicating with a central monitoring station via a network, such as the Internet, including receiving Internet content. The communication circuitry 434 can include RS232, USB, parallel and serial ports and associated circuitry, as well as network connection software and circuitry, such as a modem, DSL connection circuitry, etc. Preferably, the process of downloading/uploading data, including software updates, is configured as an interrupt for being performed during a timer interrupt by the dynamic therapy apparatus 100. As shown in FIG. 4, communication circuitry 434 is connected to the central, remote monitoring station 10 via the internet 12.

The data transmitted from the dynamic motion therapy apparatus 100 to the remote monitoring station can include video and/or sensor data obtained by a video camera and/or at least one sensor mounted to the support structure or the dynamic motion therapy apparatus 100 and transmitted via the network to the central, remote monitoring station.

Patient compliant data (directed to whether the patient is complying to treatment protocols) and other patient- and treatment-related data are preferably stored in the dynamic therapy apparatus 100 for evaluation at a later time or for transmission via the network using the communications circuitry 434 to the central monitoring station for observation. The transmission can also occur in real time during dynamic motion therapy for enabling a medical professional or other observer to transmit data via the network to the patient during the therapy session. The transmitted data can be displayed to the patient on the display unit 432 and/or audibly played via a speaker. The display unit 106 includes a graphic display 108 for providing visual feedback of the amount of mechanical vibration energy transmitted to the patient, wherein the graphical display 108 includes a graphical format, such as, for example, an icon or graph.

The transmitted data can include a message for the patient to change his posture for maximizing mechanical impedance and the transmissibility of the mechanical vibration energy through the patient. Another transmitted message can be for the patient to manually change one or more operating parameters of the dynamic therapy apparatus 100.

The data transmitted from the dynamic therapy apparatus 100 can include video and/or sensor data obtained by a video camera and/or at least one sensor mounted to the support structure or the dynamic therapy apparatus 100 and transmitted via the network to the central monitoring station.

Using the dynamic therapy apparatus 100 and mechanical impedance methods as known in the art, one can predict the transmissibility of the mechanical vibration energy through the patient being supported by a support structure, such as a kneeling chair-type support structure, wheel chair, seat, exercise device, etc., using the dynamic stiffness of the support structure and the apparent mass of the body measured at appropriate vibration magnitudes. The materials, structure, orientation, etc. of the support structure can then be selected and re-designed for maximizing the transmissibility of the mechanical vibration energy through the oscillating platform system-support structure-patient interface in order to maximize the transmissibility of the mechanical vibration energy through the patient. The support structure can in effect be custom designed for each patient for maximizing the transmissibility of the mechanical vibration energy through the patient.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1. A method for monitoring patient compliance of a patient undergoing therapeutic treatment of tissue in the patient's body, the method comprising:
supporting the patient's body patient on a platform at a treatment site;
oscillating the platform to impart an oscillating force on the body and to transmit mechanical vibration energy through the patient's body for therapeutically treating the tissue in the body;
processing data related to the therapeutic treatment; and
transmitting the data to a remote monitoring station for monitoring thereof.

2. The method as recited in claim 1, wherein said data is related to at least one treatment parameter of the platform.

3. The method as recited in claim 2, further comprising transmitting a control signal from the remote monitoring station to at least one processing device at the treatment site for remotely controlling a value of the at least one treatment parameter.

4. The method as recited in claim 2, wherein the at least one treatment parameter is a calculated weight and further comprising comparing an apparent weight of the body to the calculated weight and determining if the calculated weight substantially deviates from the apparent weight.

5. The method as recited in claim 4, further comprising determining a posture of the body as being non-compliant if the calculated weight substantially deviates from the apparent weight; and generating and transmitting a message instructing said patient to change posture.

6. The method as recited in claim 2, wherein the at least one treatment parameter is selected from a group consisting of oscillation frequency of the platform; vibrational response of a musculoskeletal system of the patient; amplitude of the frequency of the oscillating force; and time interval of the treatment.

7. The method as recited in claim 1, wherein the step of transmitting the data includes transmitting data via a communications medium.

8. The method as recited in claim 1, wherein the step of transmitting data includes transmitting data via a communication device operating in accordance with a communications protocol.

9. An apparatus for therapeutic treatment of tissue in a body of a patient, the apparatus comprising:
a platform configured to support a body of the patient;
an oscillator operably connected to the platform and configured to oscillate and impart an oscillating force at a predetermined frequency on the platform for transmitting mechanical vibration energy through the patient's body;
at least one processing device in operable communication with the oscillator for processing data related to the therapeutic treatment and controlling the oscillator; and
a communication device in operative communication with the at least one processing device and adapted for transmitting the data to a remote monitoring station via at least one network.

10. The apparatus of claim 9, wherein the at least one processing device is configured to adjust a treatment parameter to achieve a desired treatment in response to a signal received by the at least one processing device via the network.

11. The apparatus of claim 10, wherein the treatment parameter is selected from a group consisting of oscillation frequency of the platform; vibrational response of a musculoskeletal system of the patient; amplitude of the frequency of the oscillating force; and time interval of the treatment.

12. The apparatus of claim 10, wherein the data is indicative of at least one treatment parameter during oscillation of the platform.

13. The apparatus of claim 9, further comprising support means operatively connected to the platform for supporting the patient's body on the platform.

14. A system for monitoring a patient during dynamic motion therapy treatment, the system comprising:
a remote station in operative communication with at least one apparatus, the at least one apparatus comprising a platform configured to support the patient; an oscillator operably connected to the platform and configured to oscillate and impart an oscillating force at a predetermined frequency on the platform; and at least one processing device in operable communication with the oscillator for processing data related to the therapeutic treatment and controlling the oscillator; and
a communication device in operative communication with the at least one processing device of the at least one apparatus for transmitting data from the at least one apparatus to the remote station.

15. The system according to claim 14, wherein the communications device operates in accordance with a communications protocol.

16. The system as recited in claim 14, wherein the data includes a calculated weight, said remote station comprising at least one processor for comparing an apparent weight of the body to the calculated weight and determining if the calculated weight substantially deviates from the apparent weight.

17. The system as recited in claim 16, wherein the at least one processor determines a posture of the body as being non-compliant if the calculated weight substantially deviates from the apparent weight, and generates and transmits a message to the at least one processing device via the communication device, said message instructing said patient to change posture.

18. A support structure for providing vibrational treatment to a patient, the support structure comprising:
a non-rigidly supported platform capable of providing vibrational treatment to the patient in contact with the non-rigidly supported platform; and
a processor in operative communication with communications circuitry for transmitting treatment-related data via a network.

19. The support structure according to claim 18, wherein the data is patient monitoring data.

20. The support structure according to claim 19, wherein the patient monitoring data is received by a monitoring station having at least one processor for determining whether the patient is complying with a treatment regimen.

21. The support structure according to claim 19, wherein the patient monitoring data is received by a monitoring station having at least one processor for determining whether the patient is properly positioned on the non-rigidly supported platform.

22. The support structure according to claim 18, wherein the processor further receives data via the network.

23. The support structure according to claim 22, wherein the received data includes treatment-related data.

24. The support structure according to claim 22, wherein the received data includes Internet content.

25. The support structure according to claim 18, further comprising a video camera for providing video data to the processor, wherein the data transmitted by the processor is video data.

26. The support structure according to claim 18, further comprising a sensor for providing sensor data to the processor, wherein the data transmitted by the processor is sensor data.

27. A network system comprising:
a support structure having a non-rigidly supported platform capable of providing vibrational treatment to a patient in contact with the non-rigidly supported platform; and
a monitoring station in operative communication with the support structure via a network.

28. The system according to claim 37, wherein the support structure includes communication circuitry for transmitting data to the monitoring station via the network.

29. The system according to claim 28, wherein the data transmitted to the monitoring station includes patient monitoring data indicative of whether a patient is compliant with a treatment regimen.

30. The system according to claim 28, wherein the data transmitted to the monitoring station includes data for determining whether the patient is properly positioned on the non-rigidly supported platform.

31. The system according to claim 27, wherein the monitoring station transmits data via the network to the support structure, wherein the data is selected from the group consisting of treatment-related data and Internet content.

32. A method for communicating vibrational treatment-related data comprising:
providing vibrational treatment to a patient in contact with a non-rigidly supported platform; and
transmitting data related to the vibrational treatment to a monitoring station via a network.

33. The method according to claim 32, further comprising analyzing the treatment-related data for determining whether the patient is complying with a treatment regimen.

34. The method according to claim 32, further comprising analyzing the treatment-related data for determining whether the patient is properly positioned on the non-rigidly supported platform.

35. The method according to claim 32, further comprising transmitting data from the monitoring station after receiving the treatment-related data by the monitoring station.
